(19) United States
(12) Patent Application Publication
(10) Pub. No.: US 2004/0096077 A1
(43) Pub. Date: May 20, 2004

(54) Hearing coupler shells of soft pliable thermoplastic material

(76) Inventors: Peter J. Csensich, Sarasota, FL (US); Gerald Castor, Sarasota, FL (US)

Correspondence Address: HAHN LOESER & PARKS, LLP, TWIN OAKS ESTATE, 1225 W. MARKET STREET, AKRON, OH, 44313, US

(21) Appl. No.: 10/422,155

(22) Filed: Apr. 24, 2003

Related U.S. Application Data
(63) Continuation of application No. 09/300,933, filed on Apr. 28, 1999, now abandoned.
(60) Provisional application No. 60/084,465, filed on May 6, 1998.

(51) Int. Cl. H04R 25/02; H04R 25/00

(52) U.S. Cl. 381/328; 181/130

(57) ABSTRACT

A device to be insertion in an auditory canal of the ear of a human user to assist teh delievry of an auditory stimulus to the middle ear near the eardrum has a shell with a generally cone-shaped exterior defined by a larger end for positioning toward the external end of the auditory canal and a smaller end for positioning toward the internal end of the auditory canal. At least one internal passage communicates the larger end with the smaller end. the shell is formed from a material selected from the group consisting of soft thermoplastics (STP), thermoplastic elastomers (TPE), thermoplastic rubber (TPR) and any combination of the foregoing, so that it has a Shore A hardness of less than about 80 and the exterior of the shell compresses to be frictionally retained in the auditory canal of the user. In another embdiment of the device, a soft pliable shell is provided to enclose a rigid case of a hearing assistance device which is worn behind the pinna of the ear of a human user.

The present invention relates to a shell for a sound altering device for use in the auditory canal of a human user. In some instances, the device is used to amplify sound perceived near the user's ear, in other instances the device will be used to contain a receiver for receiving remote sounds, and, in a yet third instance, the device will be used to deaden sound perceived at the user's ear. More particularly, the invention relates to such an electronic coupler which is positioned in a shell which fits in the ear and may be either custom molded for a particular user or may be a stock item. Even more particularly, a soft pliable thermoplastic material is used to form the shell.

### BACKGROUND OF THE ART

Electronic hearing couplers are known in the prior art. Recent developments in the electronic arts have made such couplers smaller. Reference is now made to FIG. 1, which shows in sectional view many of the relevant structures in the ear 10 of a human user. It is now known to position such couplers directly into the external auditory canal 12, also known as the meatus. The external ear 14, also known as the pinna, is a trumpet-shaped structure which funnels sounds into the meatus 12, a relatively short tube which traverses an opening in the temporal bone 16 and terminates at its internal end at the tympanic membrane 18, or eardrum. Surrounding the opening of the meatus 12 into the pinna 14 are a variety of structures, including (from the front and moving downwardly in a clockwise direction when viewed from the exterior): the tragus (not shown in the sectional view), the antitragus 20, the antihelix 22 and the concha 24. These structures effectively form a bowl-like depression in the pinna 14 and, in combination with the meatus 12, a unique configuration is provided for each individual, and, in fact, each ear of each individual. In persons requiring hearing amplification, it is necessary to provide a clean auditory signal proximate to the tympanic membrane 18. In the past, the technique has been to seat an electronic hearing coupler in a rigid thermoplastic shell, typically made of an acrylic material, with controls and/or battery access provided in a faceplate at the exterior end of the shell. While providing an acceptable auditory signal, the rigid shell can allow sound leakage in an annular space between it and the meatus. It can also be uncomfortable to the wearer. It is therefore an advantage of the present invention to deliver an improved auditory signal to the tympanic membrane in a more comfortable manner.

### SUMMARY OF THE INVENTION

This and other advantages of the present invention are provided by a device to be inserted in an auditory canal of the ear of a human user. Such an auditory canal is surrounded at an external end by a concha which is in turn surrounded by a pinna and bounded by a tympanic membrane at an internal end thereof. The device comprises a shell with a generally cone-shaped exterior defined by a larger end for positioning toward the external end of the auditory canal and a smaller end for positioning toward the internal end of the auditory canal with at least one internal passage communicating the larger end with the smaller end. The shell is formed from a material selected from the group consisting of soft thermoplastics (“STP”), thermoplastic elastomers (“TPE”), thermoplastic rubber (“TPR”) and any combination of the foregoing.

In some embodiments the shell is a continuous matrix of the material, while in others the material is foamed to provide a plurality of closed cells throughout the matrix. The preferred hardness is less than 80, measured on the Shore A scale, although hardness as low as 2 may be useful.

In some embodiments, the shell is custom made to specifications set by an impression of the auditory canal of the intended human user, while in other situations the shell is made as a stock item to specifications set by one of a plurality of generic sizes useful to a representative sample of the population.

In some embodiments, the shell fits entirely within the auditory canal of the user, while in other cases, the external end of the shell fits within the concha of the ear of the user. In either case, the exterior of the shell compresses to be frictionally retained in the auditory canal of the user.

The shell may contain at least one electronic device selected from the group consisting of: a button receiver, a sound amplification device, a sound box and a radio receiver to provide a auditory signal for the user. In some cases, a shell is communicated to an electronic device positioned external to the ear, typically behind the pinna.

Some embodiments further comprise a ring-like element sealingly fitted around the circumference of the shell from the internal end as the device is fitted into the ear of the user.

In yet another embodiment, the soft pliable shell encloses a rigid hearing device worn behind a pinna of a human user. In such a case the shell is formed from a material selected from the group consisting of soft thermoplastics (“STP”), thermoplastic elastomers (“TPE”), thermoplastic rubber (“TPR”) and any combination of the foregoing, with a Shore A hardness of less than 8. These last embodiments may be brightly or decoratively colored and shaped to express the personality of the wearer, as well as providing more comfort.

### BRIEF DESCRIPTION OF THE DRAWINGS

The invention is best understood when reference is made to the accompanying drawings, wherein identical parts are identified with identical reference numerals, and wherein:

FIG. 1 shows a sectional view from the front of a human ear;

FIG. 2 shows a sectional view of a human ear containing a first embodiment of the present invention device;

FIG. 3 shows the device of FIG. 2 as viewed from the side, exterior to the ear;

FIG. 4 shows the device of FIG. 3 as viewed from the side, interior to the ear;

FIG. 5 shows a prior art device in a human ear;

FIG. 6 shows the device of FIG. 5 as viewed from the side, exterior to the ear;

FIG. 7 shows a sectional view of a human ear being fitted for a hearing device;

FIG. 8 shows a male mold created for a particular human ear;

FIG. 9 shows the making of a female mold for creating a soft pliable shell of the present invention;

FIG. 10 shows a resulting raw shell of the present invention;

FIG. 11 shows a sectional view of a human ear containing a second embodiment of the present invention device;

FIG. 12 shows an enlarged sectional view of the second embodiment hearing coupler shell;

FIG. 13 shows an enlarged sectional view of a variation on the second embodiment hearing coupler shell;

FIG. 14 shows an additional element being used with the embodiment of FIG. 13;

FIG. 15 shows an embodiment of the present invention wherein a soft pliable ear insert is used in combination with a hearing device worn behind the pinna;

FIGS. 16 through 20 show six different variations on an embodiment of the present invention wherein the invention comprises a soft pliable shell for a rigid case worn behind the pinna of a human user.

### DETAILED DESCRIPTION OF THE PREFERRED EMBODIMENTS

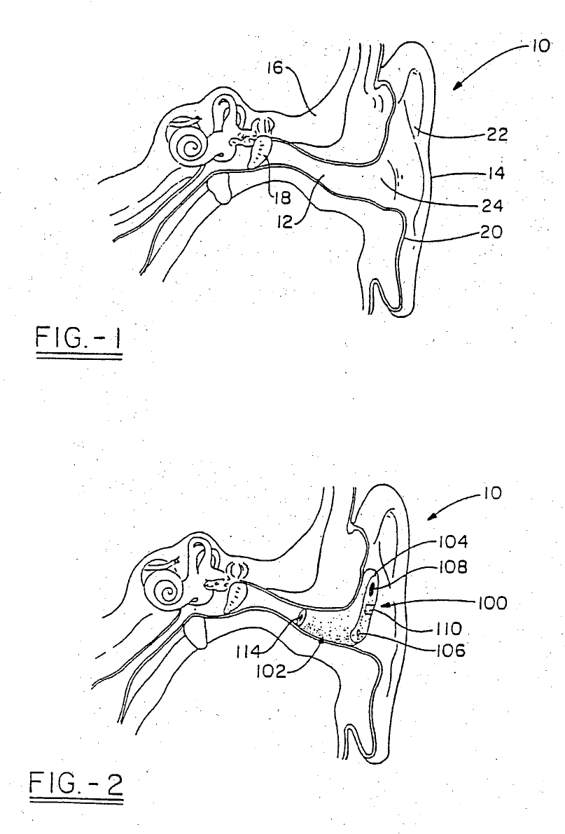

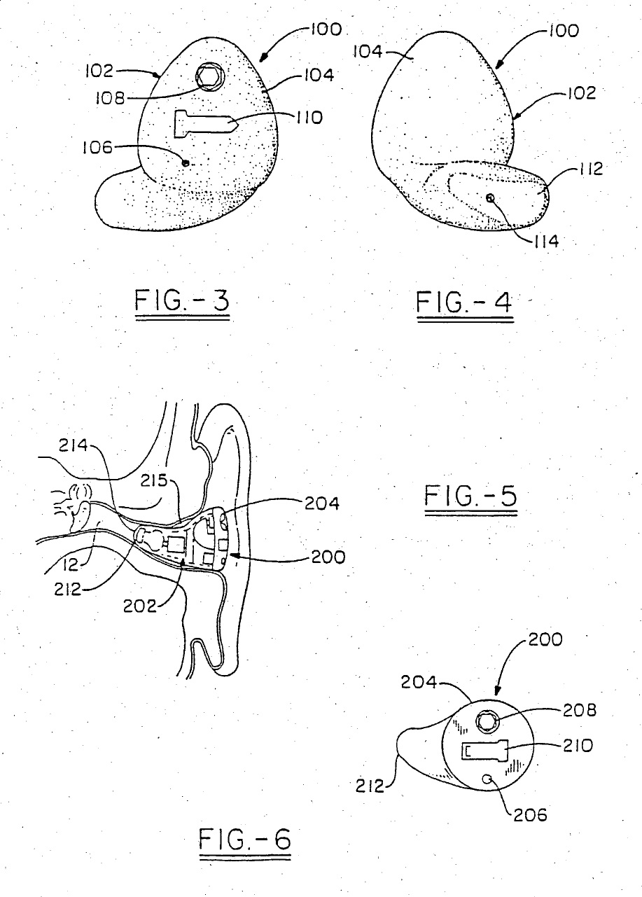

FIG. 1 has shown the internal ear structures of a human without a device 100 as in the present invention. In FIG. 2, a device 100 of the present invention is shown in place in the ear 10; in FIG. 3, a side view of the device from the exterior of the ear is provided and in FIG. 4, a side view from the interior of the ear is shown. The device 100 has a shell 102 of a soft pliable material. It receives and retains an electronic auditory coupler (not shown in this figure) in its generally cone-shaped hollow body, which is seated in the meatus 12 of a human user. At a larger end 104 of the cone-shaped shell 102, typical items are provided when the device 100 is intended for hearing amplification. These include a microphone input 106 to receive sound, a volume adjustment control 108 and a battery access port 110. These items are best viewed in FIG. 3, which is the view as taken from the exterior of the ear. When the device 100 is viewed from the smaller end 112, which is inserted into the auditory canal 12, a sound aperture 114 is provided to allow amplified sound generated in the device 100 to be directed at the tympanic membrane. Viewed from the larger end 104, the shell 102 is seen as tapering in a somewhat upwardly direction, terminating in a small opening 114 at the smaller opposite end 112. One side of the shell 102 is generally flat, to fit against the bony structures of the temporal bone near the antihelix and the right side of the shell is much more curved, to generally fit against the tragus, which is the cartilaginous knob at the front side of the ear, and which curves dorsally somewhat to shield the opening of the meatus 12. At the larger end 102, the top portion fits with the concha and the lower portion nestles behind the slight flap of the antitragus, which also serves a shielding function to the meatus.

Attention is now directed to FIGS. 5 and 6, which show a prior art device 200, viewed in a sectional view in FIG. 5 and in a external side view in FIG. 6. While the rigid thermoplastic shell 202 lines the meatus 12 and allows a electronic auditory coupler to be inserted therein, with a flexible tube (not shown) on the coupler directing an auditory signal to the small opening 214 which is proximate to the tympanic membrane when inserted in the ear, this shell has several distinct disadvantages, each of which becomes quickly known to a user. First, the need to easily position the shell 202 into the meatus mandates a slightly loose fit, such as is shown at the point indicated by reference numeral 215. There is inevitable sound leakage around the shell 202 in an annular region defined by the exterior surface of the shell and the internal surface of the meatus. The rigidity of shell 202 is not commensurate with the motions of the auditory system and particularly the slightly upturned meatus which occur during speech, mastication of food, yawning, and even general movements of the head. The rigidity of the shell 202 results in either discomfort to the wearer, movement of the device, or both, when these activities occur. The rigid shell 202 is unable to cushion blows or impacts to the head. The rigid shell 202 necessitates meeting tight tolerances when molding and then mating the shell up with a faceplate to the larger end 204. The rigid shell 202 has little or no capacity to be properly fitted to the percentage of the population who have ear canals which vary from the normal in their degree of convolution. The prior art device 200 is provided with the same external controls at the larger end 204, as shown in FIG. 6: a microphone input 206 to receive sound, a volume adjustment control 208 and a battery access port 210.

For at least these reasons, the advantages of the present invention soft pliable shell 102 over the traditional hard plastic shell 202 include the following: 1) reduction of the common phenomenon known as the occlusion effect which occurs when the ear is plugged or blocked; 2) a better fit in the ear and the ear canal which reduces the likelihood of acoustic feedback; and 3) the reduction in amplified sounds emanating by conduction through the mandible, facial bones and tempromandibular joint. These acoustic effects are well known as a source of annoyance and discomfort to the user of a hearing assistance device.

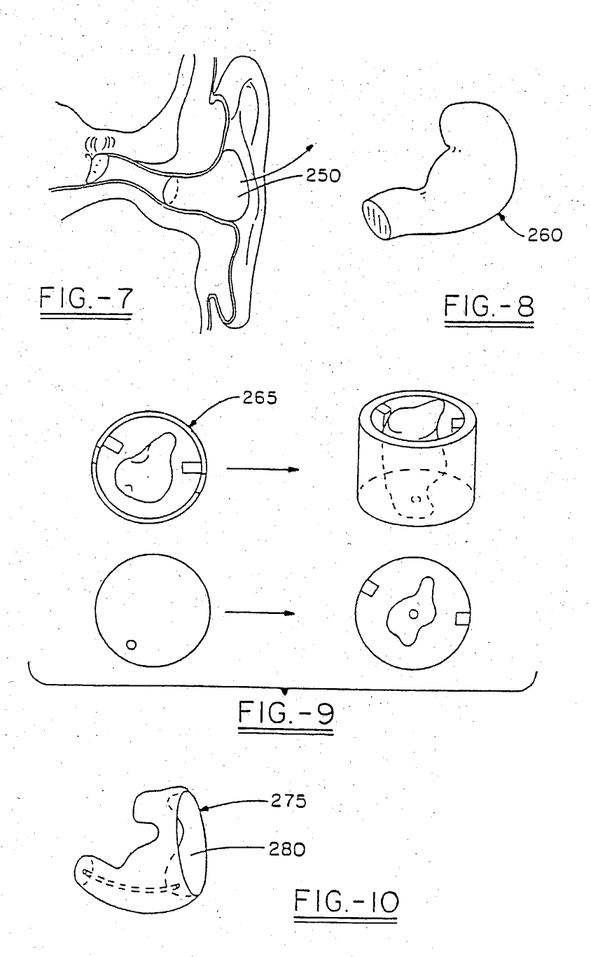

As mentioned above, a first embodiment of the invention will be a hearing coupler in a soft pliable shell 102 custom manufactured for a specific user. FIGS. 7 through 10 show the steps involved in making such a custom manufacture. The first step in making such a device is the step of obtaining a positive impression of the external ear and the external auditory canal or meatus. The process of obtaining such an impression is generally well-known and conventional techniques for making a positive impression, also referred to as a male mold, will be known to one of skill in this art. In FIG. 7, a mass of the molding material 250 is shown inserted in the ear and specifically in the meatus and concha, where it is accommodated to the size thereof. In FIG. 8, the formed male mold 260 is removed for processing. However, the invention is not limited to the use of such conventional techniques involving the insertion of the impression-making materials into the ear of the intended user, and, as the techniques become more readily available, it would be expected that the male mold 260 could be created from a computer model based upon laser interferometric readings of the relevant ear structures, just to give one example. A common material for the impression will be a silicone material, but the computer generated mold may comprise a different material, since it would never have to be physically present in the ear.

The second step in the process is to conform the male mold 260 to the requirements of the finished custom shell. Primarily, this step will involve the trimming and/or buffing of the surfaces to remove rough spots or edges, filling in any deformations or cracks with a melted wax, and coating the male mold with a thin layer of a silicone which will cure at ambient temperatures, to further smooth the surface and fill in imperfections.

The third step is shown in FIG. 9, with the preparation of a female mold 265 from which the pliable shell of the present invention will be made. A variety of acceptable techniques are known. The first of these is to place the male mold 260 into a sturdy chamber for receiving a molten material, typically a thermoplastic, which will become the female mold. The chamber must be of a material which may be easily separated from the female mold, once the latter is formed. To assist in this, it will be conventional to coat the internal surfaces of the chamber with a mold release compound, of which selection is relatively easy once the respective materials of the chamber and female mold are determined. Once coated internally, the chamber should be attached to a injection molding apparatus and the molten molding material injected under pressure to completely fill the space between the chamber and the male mold. In a variation on this step, the male mold will be placed in a molding chamber and coated to a depth of at least 0.5 inches with an epoxy-type resin as is commercially available, particularly a two-part epoxy resin which is mixed at the time of use. The coated male mold is then placed in either a compressive assembly or a vacuum assembly, the purpose of either to assure close conformity of the curing epoxy resin to the male mold. In yet a third variation, a two part urethane polymer is coated to a depth of at least 0.5 inches atop the male mold, and the curing polymer subjected to either compression or vacuum to conform the female-mold-forming compound to the male mold. In the practice of some of these techniques, it may be useful to heat the chamber while it is subjected to compression or vacuum as the polymer of the female-mold-forming compound sets up. In other known techniques, particulartly employing an exothermic curing reaction, it may be preferred to cool the chamber, typically with water flow therearound. The specific need for heating or cooling will again be known to one of skill in this art.

After the female mold has been formed so that it effectively envelopes the male mold and has cured fully, the female mold is removed from the chamber, also removing the male mold. The male mold is then removed from the female mold in a manner which allows subsequent use of the female mold to form the shell. Particularly important is the need to provide an opening for inserting a dummy member and injecting the thermoplastic material from which the shell will be formed. The dummy member will have the same (or slightly larger) dimensions as the hearing coupler which will ultimately be inserted. Unlike the female mold, which will be custom made for an individual user, the dummy member may be mass-produced, since the electrical components constituting the hearing coupler will be effectively generic. Repairs may be made to the female mold if necessary using a two-part epoxy resin or other suitable agent. Buffing using a sandpaper/metal wheel or a dremel will also be known. The dummy member should be coated with an appropriate mold release compound prior to insertion in the cavity left by the male mold in the female mold. The dummy insert should be aligned in the cavity in a manner which will render the hearing coupler insertible in a functional arrangement.

The next step is to place the female mold containing the aligned dummy insert into a chamber for injection of the pliable shell-forming material into the space between the female mold and the dummy member. Once so inserted, a thermoplastic material, which will solidify to have a Shore A durometer hardness of less than about 80 (and preferably less than about 65), is injected into the space to form the soft pliable shell. Materials which are acceptable for this shell are disclosed in more detail below. The injection molding technique is known to be amenable to having synchronous injection of more than one material into a single mold to yield a product which has mixed composition.

Once the injected thermoplastic material has solidified into the custom shell, this shell is separated from the female mold and the dummy member. As with the molds from which it came, the molded pliable custom shell should be inspected for surface defects and smoothed or buffed to correct such defects. The shell, shown as 275 in FIG. 10, is ready for further processing.

A cavity 280 will remain in the shell where the dummy member was removed. The hearing coupler, customized for the individual user if necessary, is inserted into the cavity in its operative configuration and fixed into place. A variety of means may be used for affixing the coupler in the shell cavity, including mechanical affixation or latching, adhesion using an adhesive agent, or heat welding. In any case, the hearing coupler will be effectively restricted from movement within the shell after this step has been practiced.

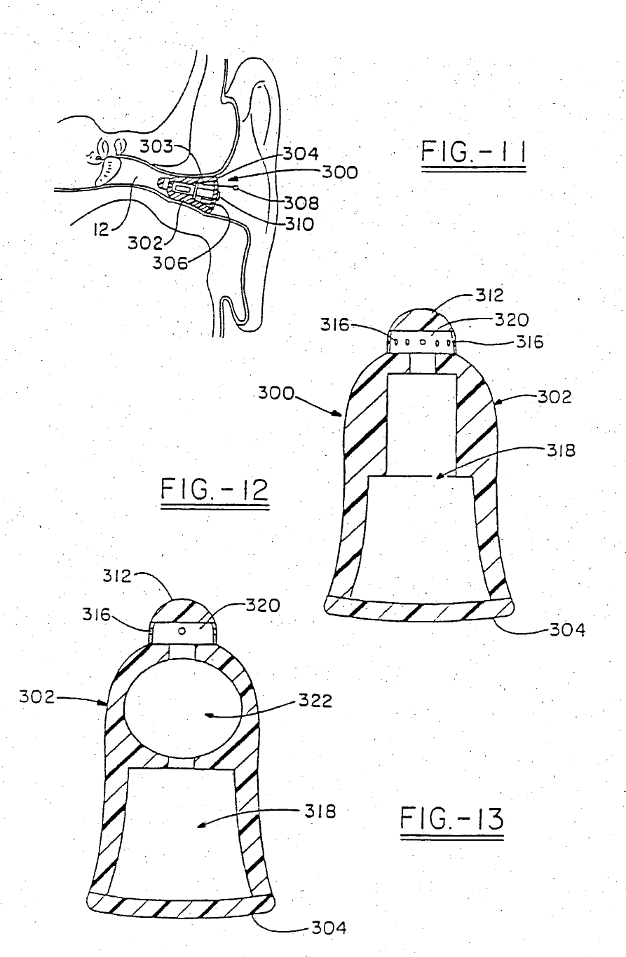

FIG. 11 shows a second embodiment device 300 of the present invention in place in the ear 10. The device 300, which is sectioned to show internal components, has a shell 302 of a soft pliable material. It receives and retains an electronic auditory coupler system 303 in its generally cone-shaped hollow body, which is seated in the meatus 12 of a human user. At a larger end 304 of the cone-shaped shell 302, typical items are provided when the device 300 is intended for hearing amplification. These include a microphone input 306 to receive sound, a volume adjustment control 308 and a battery access port 310. At the smaller end 312, amplified sound is directed into the meatus, although a plurality of apertures 316 are provided instead of a single aperture, as will be explained below. As with the first embodiment, the shell 302 is seen as tapering from the larger end 304 toward the smaller end 312, although this embodiment shell is much more uniform in shape. It will also be immediately noted that this second embodiment shell 302, at least in the preferred embodiment shown, is significantly smaller, so that it presents an “in the canal” version of the hearing device. This is a very desirable objective in many situations where the device is intended to be made as inconspicuous as possible.

Since the object of the second embodiment is to provide a stock item of commerce, the impression which will be made is not intended for use with just one particular individual. Therefore, while a series of persons may be used to generate a series of left and right ear impressions having various sizes and configurations, it is also possible that the male molds produced from the first step described above may be actual impressions, but they may also be created by an artisan skillful in creating such molds, or even from a computer-generated mold. Once formed, by whatever method, the male mold will be used to create the female mold and the soft pliable shells having an internal cavity sized and shaped to receive a hearing coupler.

When this second embodiment method of the invention is practiced, it would be highly preferred to use materials for the male mold, the female mold and the dummy insert which permit them to be used multiple times, as it is only through this multiple use that the overall cost of producing the stock shells is sufficiently reduced to justify them over the custom molding method. However, in all other aspects, the production of the stock shells is identical to the production of the custom soft pliable shells as described in detail above. It may be preferred to impart some identifying indicia in the stock shells, particularly in the surface of the cavity for receiving the hearing coupler, which facilitate the quick determination of size and or orientation (left or right ear).

Just as a method of manufacture of the present invention device has been described wherein injection molding has been used, it would also be within the scope of the invention to form a parison of the material being molded and to use conventional blow molding techniques to form the soft pliable product. Materials having the softness (as determined by the Shore A test method) required of the product will also be amenable to being formed in a conventional transfer molding process, using conventional molds as will be known to one of skill in this art.

The hearing coupler to be inserted in the shell is not really an inventive aspect of the present invention. In addition to a hearing coupler, it is possible to put a variety of electronic devices in the shells 102, 302 of the present invention. For example, it would be known to put items such as a button receiver, a sound amplification device, a sound box and a radio receiver in the shell 102, 302.

The embodiment of the invention shown in FIG. 11 is shown in an enlarged sectional view in FIG. 12. In this embodiment, the single axial opening at the smaller end has been replaced with at least one axially positioned aperture 316, and preferably, a plurality of the apertures 316 are used, as is actually illustrated. These axial apertures 316 are near the smaller end 312 instead of being directly at the smaller end. The intention of this configuration is to reduce the accumulation and retention of ear wax or cerumen. This radial aperture or apertures is also more easily cleaned of wax and other deposits than a single axial aperture. In the embodiment shown, the hollow interior of the shell is divided by the shell material into a chamber 318 for receiving the electronic device and a sound emanation chamber 320, which terminates in the axial apertures 316. In an alternate embodiment, a further sound transmission chamber 322 is provided between the chambers 318 and 320. This chamber 322 eliminates a flexible tube used in many prior art devices for transmitting sound from a sound box to the sound aperture. While flexible, such a tube would be more rigid than the shell 302 in these preferred embodiments of the invention and may prevent it from achieving the full adavantages of the soft pliable material.

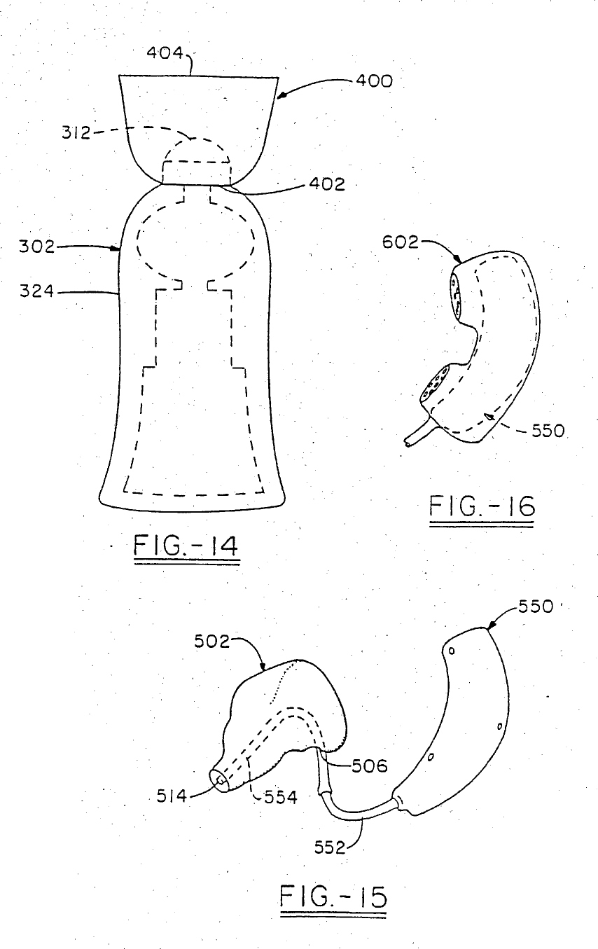

In a yet further embodiment of the invention, FIG. 14 shows shell 302, prior to insertion in an ear, with a ring-like element 400. This ring-like element 400, which will typically be much more rigid than the shell 302, is sealingly fitted around the circumference of the shell from the smaller or internal end 312 as the shell is fitted into the ear of the user. The pliable nature of the shell 302, particularly along its intermediate portion identified as 324 in FIG. 14, allows the overall combination of ring-like element and shell to be more firmly seated in the meatus. While ring-like element may be a right cylinder, the more preferred embodiment, as shown in FIG. 14, is somewhat frusto-conical, so that one end 402 is smaller in diameter than the opposing end 404. Because this element is inherently rigid, it will generally have a very thin wall, which will, in proper cases, provide a certain amount of resilient or restorative action to facilitate seating.

The preferred elastomeric materials for forming the shell of the present invention would include the class of soft thermoplastics (“STP”), thermoplastic elastomers (“TPE”) and thermoplastic rubbers (“TPR”) having a Shore A hardness of less than 80 and preferably covering a hardness range from about as low as 2 Shore A, but preferably in the range of from about 30 Shore A to about 65 Shore A. These would generally include styrenic block copolymers, polyolefin blends (TPOS), elastomeric alloys, thermoplastic polyurethanes (TPUS), thermoplastic copolyesters, thermoplastic polyamides, EPDM and others which will known to those of skill in this art. In one specific embodiment of this invention which meets the above criteria, the soft pliable shell would comprise a thermoplastic elastomer sold commercially by Advanced Elastomer Systems of Akron, Ohio, under the trademark SANTOPRENE7. As understood by the inventors from information commercially available on the preferred material, the SANTOPRENE7 polymer is an ethylene-propylene copolymer.

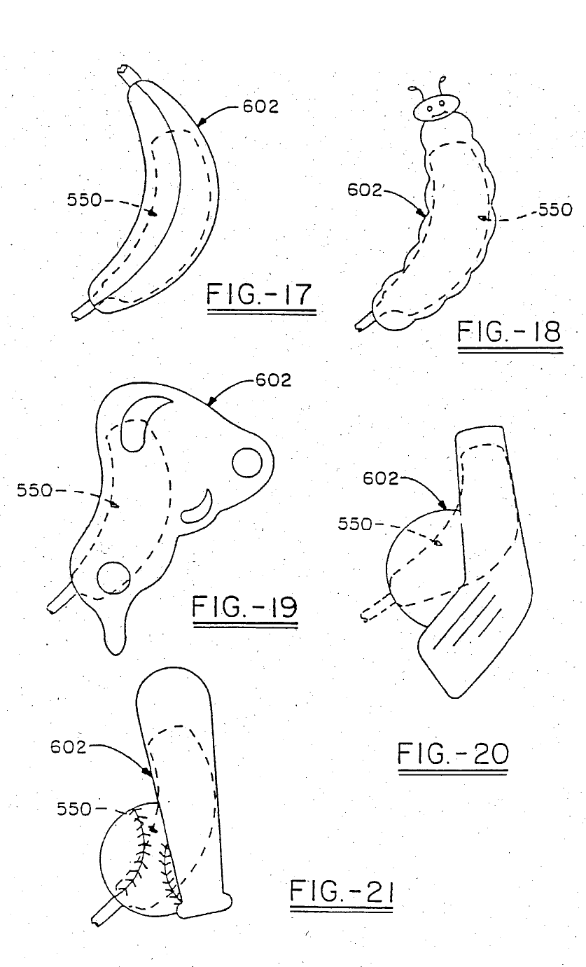

While the embodiments presented so far of the present invention describe a hearing device for the ear in which the entire hearing coupler electronics are contained in the shell, there are situations where the amount of amplification, etc., simply does not permit this. In such a situation, as is illustrated in FIG. 15, the shell 502 inserted into the ear contains no electronics, volume control or battery. All of the hearing electronics are contained in a case 550, generally a rigid plastic material, which can be positioned around the rear side of the pinna of the user. A flexible tube 552 transmits the amplified sound into a port 506 which would be typically replace the microphone port 306 of the embodiments described before. Port 506 would communicate the sound through a single passage 554 to a sound aperture 514, analogous to aperture 114,214 or the like. IN some of these situations where the size of the case 500 effectively precludes it from being inconspicuous, it may be preferable by some users of the device as shown in FIG. 15 to have a pliable shell 602, in which rigid case 550 may be housed. Some variations on this concept are presented in FIGS. 16 through 21. While the generally accepted practice in forming the ear insert type of devices such as shells 102, 202, 302 and 502 to simulate skin color to minimize their visbility, it may be just as important in the case of pliable shell 602 for covering an already visible rigid case 550 to make the shell 602 readily visible and even conspicuous. For that reason, colors, and even bright colors may be the normal mode of practice. To run through some of the possible variations, FIG. 16 shows a shell 602 which would resemble a telephone receiver, FIG. 17 shows a shell 602 which would resemble a banana, FIG. 18 shows a shell 602 which would resemble a caterpiller, FIG. 19 shows a shell which would resemble a butterfly, FIG. 20 shows a shell 602 which resembles a hockey stick and a puck and FIG. 21 shows a shell 602 which resembles a baseball bat and ball. Although not specifically illustrated, team colors and logos could be licensed for use, as could popular characters and the like. Even though the shells 602 have a clear function of expressing the personality of the wearer, the soft pliable nature of the shell also increases the comfort of wearing the device and protects a senstive area of the body where the bone lies below a thin skin surface.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. A device for insertion in an auditory canal of the ear of a human user, said auditory canal being surrounded at an external end by a concha which is in turn surrounded by a pinna and bounded by a tympanic membrane at an internal end, said device comprising a shell having a generally cone-shaped exterior defined by a larger end for positioning toward the external end of the auditory canal and a smaller end for positioning toward the internal end of the auditory canal with at least one internal passage communicating the larger end with the smaller end, said shell formed from a material selected from the group consisting of soft thermoplastics (STP), thermoplastic elastomers (TPE), thermoplastic rubber (TPR) and any combination of the foregoing.

2. The device of claim 1 wherein the shell is a continuous matrix of the material.

3. The device of claim 1 wherein the shell is foamed into a matrix of the material containing a plurality of closed cells.

4. The device of claim 1 wherein the shell is formed from STP having a Shore A hardness of less than 80.

5. The device of claim 1 wherein the shell is formed from TPE having a Shore A hardness of less than 80.

6. The device of claim 1 wherein the shell is formed from TPR having a Shore A hardness of less than 80.

7. The device of claim 1 wherein the shell is formed from a combination of two or more of the materials selected from the group consisting of STP, TPE and TPR, with a combination having a Shore A hardness of less than 80.

8. The device of claim 1 wherein the shell is custom made to specifications set by an impression of the auditory canal of the intended human user.
an impression of the auditory canal of the intended human user.

9. The device of claim 1 wherein the shell is made as a stock item to specifications set by one of a plurality of generic sizes useful to a representative sample of the population.

10. The device of claim 1 wherein the shell fits entirely within the auditory canal of the user.

11. The device of claim 1 wherein the external end of the shell fits within the concha of the ear of the user.

12. The device of claim 1 wherein the exterior of the shell compresses to be frictionally retained in the auditory canal of the user.

13. The device of claim 1 wherein one of the at least one said internal passages in the shell houses at least one electronic device selected from the group consisting of: a button receiver, a sound amplification device, a sound box and a radio receiver.

14. The device of claim 13 wherein said at least one electronic device is self-constained within the shell.

15. The device of claim 13 wherein said at least one electronic device is communicated to a further electronic device positioned external to the ear.

16. The device of claim 13 wherein the one of the at least one said internal passages housing the at least one electronic device further has a plug or gasket element to acoustically isolate the electronic devices from each other.

17. The device of claim 13 wherein the internal passage comprises at least two interconnected chambers, the first of the chambers for housing the at least one electronic device.

18. The device of claim 13 wherein the device further comprises a ring-like element is fitted into the ear of the user.

19. A shell for enclosing a rigid hearing device worn behind a pinna of a human user, said shell formed from a material selected from the group consisting of soft thermoplastics (STP), thermoplastic elastomers (TPE), thermoplastic rubber (TPR) and any combination of the foregoing.
